(19) United States
(12) Patent Application Publication
(10) Pub. No.: US 2014/0069878 A1
(43) Pub. Date: Mar. 13, 2014

(54) RACKING SYSTEM FOR SUPPORTING PHOTOVOLTAIC MODULE MOUNTING AND METHODS OF ITS USE

(71) Applicants: Max William Reed, Niwot, CO (US); Daniel Joshua Hipwood, Englewood, CO (US)

(72) Inventors: Max William Reed, Niwot, CO (US); Daniel Joshua Hipwood, Englewood, CO (US)

(73) Assignee: PRIMESTAR SOLAR, INC., Arvada, CO (US)

(21) Appl. No.: 13/607,917

(22) Filed: Sep. 10, 2012

(51) Int. Cl. F24J 2/52; B23Q 3/00

(52) U.S. Cl. 211/41.1; 29/464

(57) ABSTRACT

Racking systems for supporting a photovoltaic module are provided. The racking system includes a support lip; a lower retaining wall substantially oriented in a retaining plane and extending from the lower retaining wall; a lower support wall substantially oriented in a support plane and positioned on an opposite side of the lower retaining wall than the support lip; and an upper support wall substantially oriented in the support plane. The lower retaining wall and the lower support wall are joined together by a resting rail to define a retaining groove therebetween. Methods are also provided for mounting a photovoltaic module onto a racking system.

### FIELD OF THE INVENTION

The present subject matter relates generally to a racking system for supporting a photovoltaic module (i.e., a solar panel) and, more particularly, to a rack support configured for use with such a racking system.

### BACKGROUND OF THE INVENTION

Solar power is considered one of the cleanest, most environmentally friendly energy sources presently available, and photovoltaic module arrays have gained increased attention in this regard. Typically, the racking system for a ground-mounted photovoltaic module array includes an upper assembly configured to support the photovoltaic modules and one or more foundation posts coupled between the upper assembly and the ground. The coupling between the upper assembly and the foundation posts typically requires a strong mechanical bound and multiple degrees of freedom to allow for site variation and tolerances.

Due to their weight and overall size, fully assembled photovoltaic modules can be difficult to handle, especially when attempting to load them into a rack of a solar array. Compounding this issue is the fact that most of the currently available racking systems generally have the requirement that an installer(s) support most, if not all, of the weight of the module during the mounting process. In some systems, the installer(s) must extend the module out away from his/her body to make connection to the rack.

As such, a more installer friendly racking system and method would be welcomed in the art.

### BRIEF DESCRIPTION OF THE INVENTION

Aspects and advantages of the invention will be set forth in part in the following description, or may be obvious from the description, or may be learned through practice of the invention.

Racking systems are generally provided for supporting a photovoltaic module. In one embodiment, the racking system includes a support lip; a lower retaining wall substantially oriented in a retaining plane and extending from the lower retaining wall; a lower support wall substantially oriented in a support plane and positioned on an opposite side of the lower retaining wall than the support lip; and an upper support wall substantially oriented in the support plane. The lower retaining wall and the lower support wall are joined together by a resting rail to define a retaining groove therebetween.

Methods are also generally provided for mounting a photovoltaic module onto a racking system, such as the racking system described above. For example, a lower edge of the back structure of the photovoltaic module can be posited into a corner junction defined by a support lip extending from a lower retaining wall. The back structure can then be pivoted such that an upper edge of the back structure rests against an upper support wall. The photovoltaic module is lifted to slide the upper edge of the back structure against the upper support wall and past an upper end of the upper support wall such that the lower edge clears an upper end of the lower retaining wall. The back structure can then be pivoted such that the lower edge rests against a lower support wall positioned on an opposite side of the lower retaining wall than the support lip. The back structure of the photovoltaic module is then lowered such that the lower edge enters a retaining groove defined between the lower retaining wall and a lower support wall. Finally, the lower edge of the back structure of the photovoltaic module is positioned onto a resting rail extending between the lower retaining plane and the lower support wall. The lower edge and the upper edge of the back structure are substantially oriented in a support plane defined by the lower support wall and the upper support wall.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of a racking system for supporting a photovoltaic module;

FIG. 2 illustrates a side view of another embodiment of a racking system for supporting a photovoltaic module;

FIG. 3 illustrates a side view of the racking system shown in FIG. 1 or 2 accepting a photovoltaic module in a first mounting step;

FIG. 4 illustrates a side view of the racking system shown in FIG. 1 or 2 accepting a photovoltaic module in a second mounting step;

FIG. 5 illustrates a side view of the racking system shown in FIG. 1 or 2 accepting a photovoltaic module in a third mounting step;

FIG. 6 illustrates a side view of the racking system shown in FIG. 1 or 2 accepting a photovoltaic module in a fourth mounting step;

FIG. 7 illustrates a side view of the racking system shown in FIG. 1 or 2 accepting a photovoltaic module in a fifth mounting step; and

FIG. 8 illustrates a side view of the racking system shown in FIG. 1 or 2 accepting a photovoltaic module in a sixth mounting step.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter discloses a racking system for supporting a photovoltaic module. The racking system can be utilized to form a solar array by mounting a plurality of photovoltaic modules adjacent to each other. As will be apparent from the description below, the disclosed racking system provides a simple, cost effective means for mounting photovoltaic modules into a solar array. Specifically, the components of the rack support may be fabricated from industry standard materials, thereby allowing flexibility in manufacturing and reducing manufacturing costs. Additionally, the configuration of the rack support eliminates the need for secondary machining and/or drilling when coupling the supports posts to the racking assembly. As such, installation may be simplified, thereby lowering installation costs.

Also, as will be apparent from the following description, the presently described racking system accepts a substantial amount of weight of the photovoltaic module during the mounting process. As such, the installation process can be easier to achieve, and can be more ergonomic for the installer.

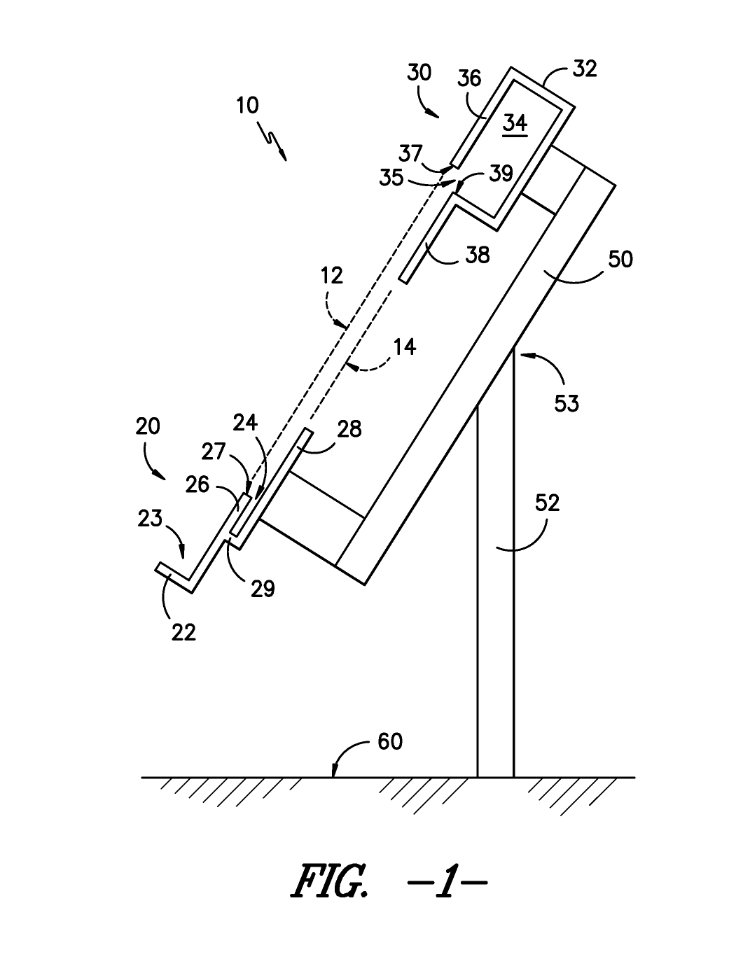

FIG. 1 shows an exemplary racking system 10 according to one embodiment of the present invention. The racking system 10 includes a lower mounting unit 20 and an upper mounting unit 30. For example, the lower mounting unit 20 generally includes a support lip 22, a lower retaining wall 26, and a lower support wall 28. The upper mounting unit 30 generally includes an upper rail 32 connected to an upper retaining wall 36 and an upper support wall 38. Although shown as separate units 20, 30, it is to be understood that these units 20, 30 can be joined together (e.g., via a support wall bridging the lower support wall 28 and the upper support wall 38, as discussed below).

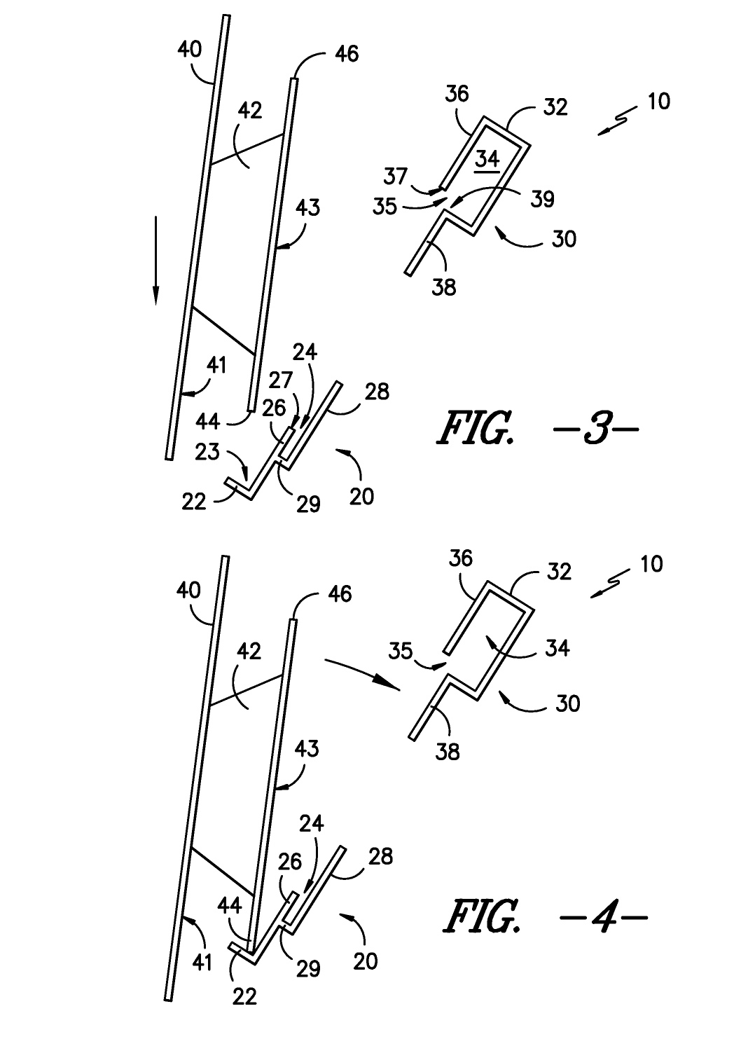

As stated, the lower mounting unit 20 of the racking system 10 generally includes a support lip 22 that extends from the lower retaining wall 26 (generally oriented in a retaining plane 12). The support lip 22 can extend from the lower retaining wall 26 at a relative angle (between the retaining plane 12 and the direction the support lip 22 is oriented) that is about 60° to about 120°, such that a corner junction 23 is formed. For example, the support lip 22 extends substantially perpendicular to the lower retaining wall 26, in particular embodiments. As such, the corner junction 23 is particularly suitable for receipt of the lower edge 44 of the back structure 42 of the photovoltaic module 40 as shown in FIG. 3, and for subsequent pivoting of the photovoltaic module 40 on its lower edge 44 of the back structure 42 as shown in FIG. 4.

Due to the orientation of the lower unit 20, both of the support lip 22 and the lower retaining wall 26 are oriented at an angle relative to the ground plane 60. For example, the support lip 22 can be oriented in a direction that is about 15° to about 75° from the ground plane 60, such as about 25° to about 65° from the ground plane 60. For instance, in one embodiment, the support lip 22 is oriented in a direction that is about 40° to about 50° from the ground plane 60. Similarly, the retaining plane 12 of the lower retaining wall 26 can be about 15° to about 75° from the ground plane 60, such as about 25° to about 65° from the ground plane 60. For instance, in one embodiment, the retaining plane 12 of the lower retaining wall 26 is about 40° to about 50° from the ground plane 60.

In another embodiment, the racking system 10 can be used to mount a photovoltaic module to the side of a building or a wall, for example. In such an embodiment, the retaining plane 12 could be substantially perpendicular (e.g., vertical) to the ground plane 60.

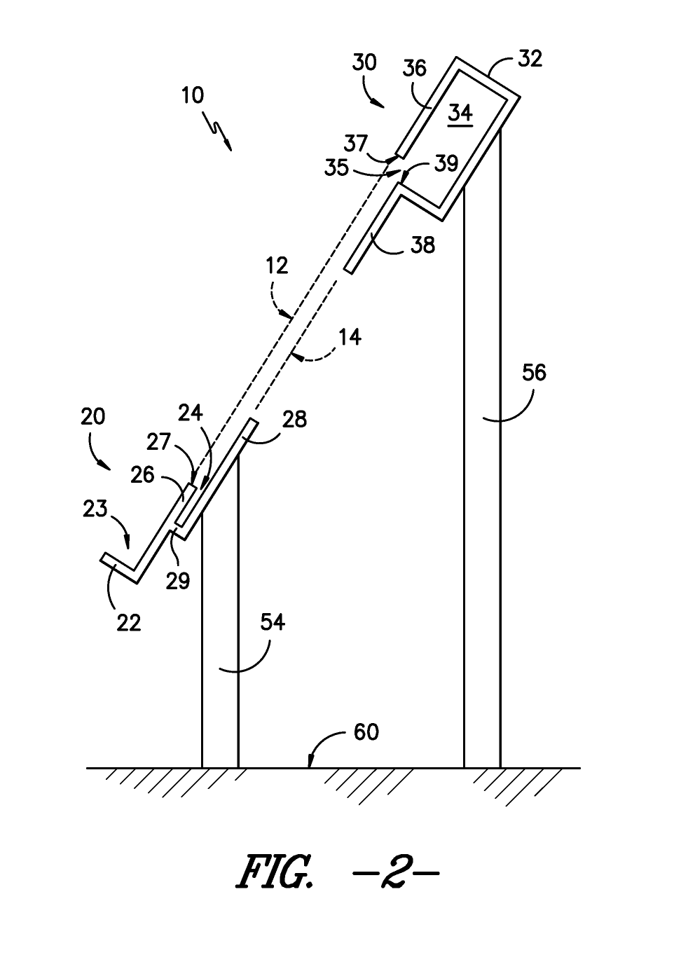

The lower support wall 28 is generally oriented in a support plane 14, and is positioned on an opposite side of the lower retaining wall 26 than the support lip 22. The lower retaining wall 26 and the lower support wall 28 are joined together by a resting rail 29 to define a retaining groove 24 therebetween. The resting rail 29 can be oriented in a direction that is about 60° to about 120° from the direction of the support lip 22. In one particular embodiment, the resting rail 29 generally parallel to the support lip 22 as shown in FIGS. 1-2.

The upper mounting unit 30 of the racking system 10 generally includes an upper support wall 38 substantially oriented in the support plane 14. As explained below with reference to FIG. 3-8, the upper edge 46 contacts the upper support wall 38 during the mounting process and comes to rest and/or secured thereto.

In the embodiment shown in FIGS. 1-2, the upper mounting unit 30 also includes an upper support wall 38 substantially oriented in the support plane 14, where the upper retaining wall 36 and the upper support wall 38 are connected via an upper rail 32 to define a mounting cavity 34. A mounting aperture 35 is generally defined in the open area between the lower end 37 of the upper retaining wall 36 and the upper end 39 of the upper support wall 38. In the embodiment shown, the lower end 37 of the upper retaining wall 36 does not extend over the upper end 39 of the upper support wall 38. As such, the upper edge 46 can be easily inserted into the mounting cavity 34 via the mounting aperture 35. The upper rail 32 is generally sized and shaped to allow for receipt of the upper edge 46 into the mounting cavity 34 via the mounting aperture 35 and pivoting therein such that the back structure 42 is oriented in the support plane 14.

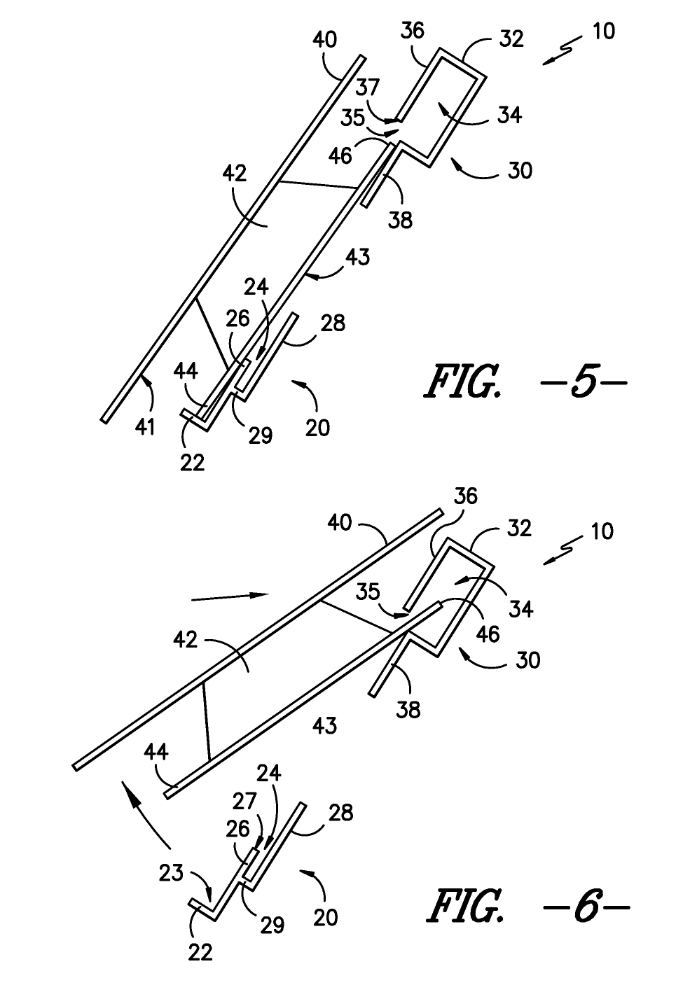

In another embodiment, the upper unit 30 can only include an upper support wall 38 defining an upper end 39 (i.e., without an upper retaining wall 36 and/or the upper rail 32) that allows for the pivot action of the back structure 42 shown in FIG. 5-7.

As shown in FIG. 1, the lower mounting unit 20 and the upper mounting unit 30 are both individually connected to a bracket 50. The bracket 50 is, in turn, connected to a post 52. In one embodiment, the bracket 50 is rotationally connected to the post 52 at a pivot point 53. In this embodiment, racking system 10 can rotate the mounted photovoltaic modules in a direction desired, which can change depending on the time of day and/or season of the year.

Alternatively, as shown in the embodiment of FIG. 2, the lower mounting unit 20 and the upper mounting unit 30 are connected to an individual post 54, 56, respectively.

FIGS. 3-8 sequentially show the positioning of a photovoltaic module 40 during the mounting process into the racking system 10 (e.g., of either FIG. 1 or 2). The photovoltaic module 40 includes a back structure 42 that has a lower edge 44 and an upper edge 46. The lower edge 44 and the upper edge 46 on the back structure 42 are generally spaced apart from the back surface 41 of the photovoltaic module 40. The back structure 42 is adhered, in one particular embodiment, to the back surface 41 (e.g., defined by an encapsulation substrate). In the embodiment shown, the lower edges 44 and the upper edge 46 are oriented substantially parallel to each other to define a common plane, which is particular suitable for use in the racking system 10. As discussed below and shown in FIG. 8, the lower edges 44 and the upper edge 46 are positioned in the support plane 14 once the photovoltaic module 40 is mounted onto the racking system 10.

As will be apparent below, the racking system 10 is particularly suitable for frameless photovoltaic modules 40, since no mounting mechanism on the side edge of the module 40 is relied upon to support the module. In fact, the embodiments shown in FIGS. 3-8 do not require that the racking system 10 even contact the photovoltaic module 40 anywhere but on the back structure 42.

FIG. 3 shows the photovoltaic module 40 being positioned such that the back structure 42 is facing the racking system 10. Specifically, the back structure 42 is positioned such that the lower edge 44 is above the support lip 22 of the lower unit 20. Then, the lower edge 44 of the back structure 42 can be rested onto the support lip 22 and fitted into the corner junction 23, as shown in FIG. 4. As such, the weight of the photovoltaic module 40 is supported by the lower unit 20 in the corner junction 23 defined by the support lip 22 and the lower retaining wall 26. The installer is therefore saved from supporting the weight of the photovoltaic module 40 during the installation process.

After resting the lower edge 44 of the back structure 42 within the corner junction 23, the photovoltaic module 40 can be pivoted such that the lower edge 44 of the back structure 42 rests on the support lip 22 and the upper edge 46 of the back structure 42 rests against the upper support wall 38. As such, upper and lower mounting units 20, 30 are, in the embodiment shown, positioned and sized such that the upper edge 46 of the back structure 42 can rotate past the lower end 37 of the upper retaining wall 36 to contact the upper support wall 38.

In another embodiment, the upper unit 30 can only include an upper support wall 38 defining an upper end 39 (i.e., without an upper retaining wall 36 and/or the upper rail 32) that allows for the pivot action of the back structure 42 shown in FIG. 5-7.

As shown in FIGS. 5-6, the photovoltaic module 40 is lifted such that the upper edge 46 of the back structure 42 slides against the upper support wall 38 and past the upper end 39 of the upper support wall 38. As such, the back surface 43 of the back structure 42 can slide across the upper end 39. In the embodiment shown in FIGS. 5-6, the upper edge 46 enters the mounting cavity 34 defined within the upper rail 32 via the mounting aperture defined between the lower end 37 of the upper retaining wall 36 and the upper end 39 of the upper support wall 38.

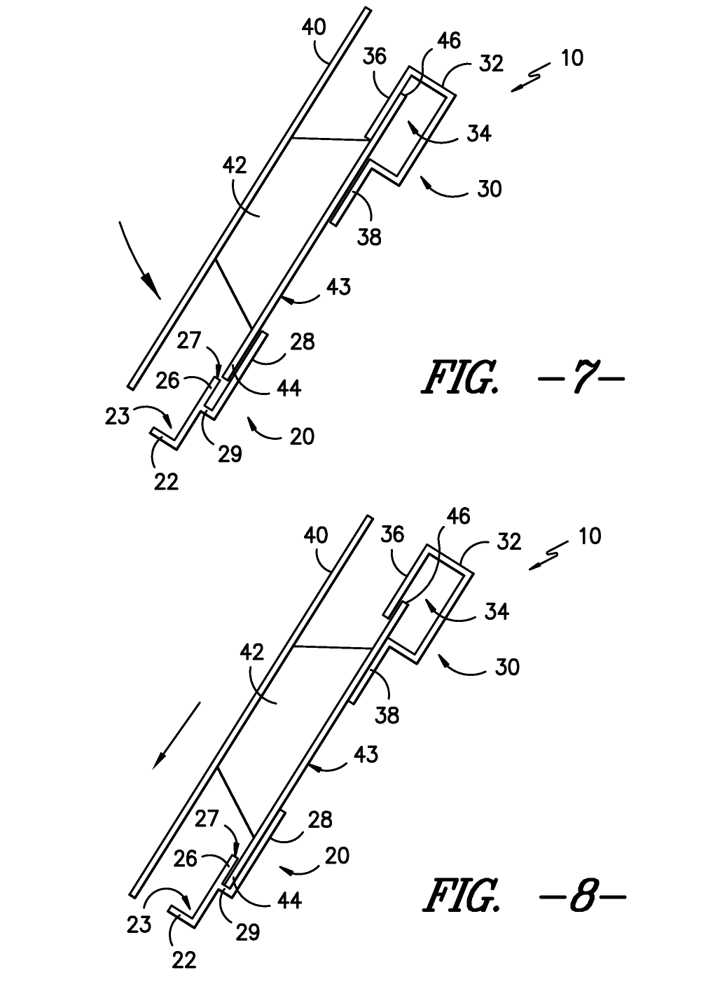

In the steps of FIGS. 5-6, the photovoltaic module 40 is lifted a distance sufficient such that the lower edge 44 of the back structure 42 clears an upper end 27 of the lower retaining wall 26. Thus, after lifting, the photovoltaic module 40 can be pivoted such that the back structure 42 rests in the support plane 14 against the lower support wall 28 and the upper support wall 38, as shown in FIG. 7. Specifically, the lower edge 44 contacts the lower support wall 28.

Finally, as shown in FIG. 8, the lower edge 44 of the back structure 42 of the photovoltaic module 40 is lowered into the retaining groove 24 defined between the lower retaining wall 26 and a lower support wall 28. As such, the lower edge 44 of the back structure 42 can be rested onto the resting rail 29 extending between the lower retaining wall 26 and the lower support wall 28.

In certain embodiments, the back structure 42 of the photovoltaic module 40 is secured into the retaining groove 24 (e.g., to the lower support wall 28). For example, the back structure 42 can be secured via a fastening mechanism (e.g., a screw, a bolt, an adhesive material, a weld, etc.) to the lower support wall 28. In addition, or in the alternative, the back structure 42 of the photovoltaic module 40 can be secured to the upper support wall 38.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A racking system for supporting a photovoltaic module, the racking system comprising:
a support lip;
a lower retaining wall substantially oriented in a retaining plane, wherein the support lip extends from the lower retaining wall;
a lower support wall substantially oriented in a support plane and positioned on an opposite side of the lower retaining wall than the support lip, wherein the lower retaining wall and the lower support wall are joined together by a resting rail to define a retaining groove therebetween; and,
an upper support wall substantially oriented in the support plane.

2. The racking system as in claim 1, wherein the support lip, the lower retaining wall, and the lower support wall define a lower mounting unit.

3. The racking system as in claim 1, further comprising:
an upper retaining wall substantially oriented in the retaining plane, wherein the upper support wall and the upper retaining wall are connected via an upper rail to define a mounting cavity.

4. The racking system as in claim 3, wherein the mounting cavity is accessible via a mounting aperture defined between a lower end of the upper retaining wall and an upper end of the upper support wall.

5. The racking system as in claim 3, wherein the upper support wall, the upper retaining wall, and the upper rail define an upper mounting unit.

6. The racking system as in claim 3, wherein the support lip, the lower retaining wall, and the lower support wall define a lower mounting unit, and wherein the lower mounting unit is separate from the upper mounting unit.

7. The racking system as in claim 6, wherein the lower mounting unit and the upper mounting unit are each individually connected to a bracket.

8. The racking system as in claim 7, wherein the bracket is rotationally connected to a post.

9. The racking system as in claim 1, wherein the support lip extends from the lower retaining wall at an angle of about 60° to about 120°.

10. The racking system as in claim 9, wherein the support lip extends substantially perpendicular from the lower retaining wall.

11. The racking system as in claim 9, wherein the support lip is oriented in a direction that is about 15° to about 75° from a ground plane.

12. The racking system as in claim 9, wherein the support lip is oriented in a direction that is about 25° to about 65° from a ground plane.

13. The racking system as in claim 9, wherein the retaining plane of the lower retaining wall is about 15° to about 75° from a ground plane.

14. The racking system as in claim 9, wherein the retaining plane of the lower retaining wall is about 25° to about 65° from a ground plane.

15. A method of mounting a photovoltaic module onto a racking system, the photovoltaic module defining a back structure having a lower edge and an upper edge, the method comprising:
positioning the lower edge of the back structure of the photovoltaic module into a corner junction defined by a support lip extending from a lower retaining wall;
pivoting the back structure such that an upper edge of the back structure rests against an upper support wall;
lifting the photovoltaic module to slide the upper edge of the back structure against the upper support wall and past an upper end of the upper support wall such that the lower edge clears an upper end of the lower retaining wall;
pivoting the back structure such that the lower edge rests against a lower support wall, wherein the lower support wall is positioned on an opposite side of the lower retaining wall than the support lip;
lowering the back structure of the photovoltaic module such that the lower edge enters a retaining groove defined between the lower retaining wall and a lower support wall, and,
positioning the lower edge of the back structure of the photovoltaic module onto a resting rail extending between the lower retaining plane and the lower support wall, wherein the lower edge and the upper edge of the back structure are substantially oriented in a support plane defined by the lower support wall and the upper support wall.

16. The method as in claim 1, further comprising:
securing the lower edge of the back structure of the photovoltaic module into the retaining groove.

17. The method as in claim 1, further comprising:
securing the lower edge of the back structure of the photovoltaic module to the lower support wall.

18. The method as in claim 1, further comprising:
securing the upper edge of the back structure of the photovoltaic module to the upper support wall.

19. The method as in claim 1, wherein lifting the photovoltaic module causes the upper edge of the back structure to enter a mounting cavity defined within an upper rail having an upper retaining wall substantially oriented in a retaining plane and the upper support wall substantially oriented in the support plane.

20. The method as in claim 15, wherein the support lip extends substantially perpendicular from the lower retaining wall.
